(19) United States
(12) Patent Application Publication
(10) Pub. No.: US 2011/0150425 A1
(43) Pub. Date: Jun. 23, 2011

(54) SYSTEM AND METHOD FOR ACTIVELY MANAGING PLAY BACK OF DEMO CONTENT BY A DISPLAY DEVICE BASED ON SIGNALING FROM A PRESENCE SENSOR

(75) Inventors: Brant L. Candelore, San Diego, CA (US); Peter Shintani, San Diego, CA (US)

(73) Assignees: SONY CORPORATION, Tokyo (JP); SONY ELECTRONICS INC., Park Ridge, NJ (US)

(21) Appl. No.: 12/643,697

(22) Filed: Dec. 21, 2009

(51) Int. Cl. H04N 5/91; G08B 21/00; H04N 9/80; H04N 5/76

(52) U.S. Cl. 386/250; 340/670; 386/E05.003; 386/291

(57) ABSTRACT

An embodiment of the invention involves an apparatus and method for controlling periodic play back of demo content by a display device. The method comprises monitoring for a triggering event by a presence sensor within the display device. The triggering event involves a detection of a non-moving or slow-moving object remaining in front of the display device for a predetermined period of time. In response to detecting the triggering event, the demo content is automatically played for a first period of time. Thereafter, play back of the demo content is halted after the first period of time has elapsed and play back the streaming advertising content is continued by the display device for a second period of time, and as an option, even if another triggering event is detected during the second period of time. Other embodiments are described and claimed.

### FIELD

The invention generally relates to the field of consumer electronics. More particularly, one and more embodiments of the invention relate to a display device and method for actively managing play back of demo content, especially within a non-assisted commercial environment, based on signaling from a sensor which detects a presence of a customer being situated in front of the display device for a prolonged period of time.

### BACKGROUND

Over the last decade, the purchasing experience for televisions and other consumer electronics has changed dramatically. Previously, consumer electronic retailers provided “assisted” commercial environments in which store personnel were trained to explain differences between competing consumer electronic products. In the sale of televisions for example, store personnel were given access to remote controls associated with each type of television on display. By having access to the remote controls, the store personnel were able to place the consumer electronic products into a various modes of operation in order to explain certain features and better respond to certain inquiries raised by customers.

As an example, if a customer was interested in a particular consumer electronic product such as a flat panel television, certain store personnel had access to the remote control associated with that particular television on display. The store personnel could turn on the television, could explain the capabilities of the television to the customer, and could place the television into a demo mode in order to illustrate features of this television. In many cases, the information provided by the store personnel and/or the content displayed during demo mode sufficiently explained why a particular television was better than other televisions in the marketplace. As a result, the customer was provided more detailed information concerning prized features of the television, and thus, was better able to make an educated decision as to which television to purchase rather than simply purchasing the less expensive television.

Unfortunately, over the last decade, the purchasing environment has changed from an “assisted” commercial environment to a “non-assisted” commercial environment that are used by big-box retailers such as COSTCO®, SAM'S CLUB®, WALMART® and the like. In a “non-assisted” commercial environment, a big-box retailer typically places a number of consumer electronic products in the same general location where it is difficult for store personnel or the customer to access.

As an illustrative example, where the consumer electronic products are flat panel televisions, the flat panel televisions are arranged in a display to prevent the customer from having physical access to the front or side control panels of these televisions. More specifically, the flat panel televisions are elevated above and recessed away from the aisle walkway so that the customer can see the displays and bezels of the flat panel televisions, but he or she is discouraged from accessing their control panels. Also, placement of the televisions behind boxed televisions mitigates the likelihood of a customer accessing the control panel of a selected television.

For these big-box retailers, all of the televisions are tuned to an in-store channel that provides streaming advertising content. However, the advertising content is not designed to highlight features of any particular television in order to assist the customer in his or her purchasing decision. Rather, the advertising content is a series of ads, normally not in high-definition, to promote various television shows and encourage the purchase of other products or services provided by the big-box retailer. Third parties, such as device manufacturers for example, are permitted to purchase advertising space within the streaming content, but such advertisements are infrequently purchased because they are extremely expensive. As a result, in this non-assisted commercial environment, customers simply rely on picture clarity and tend to have difficulties in discerning the true capabilities of the televisions when viewing the displayed advertising content.

As an illustrated example, the streaming advertising content provided over the in-store channel may be slow-moving images provided over standard definition or high-definition programming with minimum resolution (e.g., 720p supports a resolution of 1280×720 and a frame rate of 24 hertz “Hz”). As a result, when viewing the in-store advertising content, customers will have difficulty in noticing major differences in picture clarity between the televisions on display, unlike the situation where the televisions are displaying high-resolution video of fast-paced sporting events, such as hockey or NASCAR for example. For this type of content, 1080p televisions that support higher resolution video, motion interpolation and/or higher refresh rates (e.g., rates ≧120 Hz) will provide superior picture quality over the lower priced 720p televisions that only support up to a 60 Hz refresh rate.

It would be advantageous to the customers to allow manufacturers to showcase features of their electronic devices through play back of a demo without substantially interrupting the streaming of the advertising content used as a revenue base by the big-box retailer. Additionally, it would be advantageous for the activation of the demo to be predicated on detected persons standing or waiting in front of the particular display device.

### BRIEF DESCRIPTION OF THE DRAWINGS

Embodiments of the invention may best be understood by referring to the following description and accompanying drawings that are used to illustrate embodiments of the invention.

FIG. 1 is an exemplary embodiment of one or more display devices displayed for sale in a non-assisted commercial environment.

FIG. 2A is an exemplary embodiment of a display device illustrated in FIG. 1 that supports an enhanced demo mode.

FIG. 2B is an embodiment of components implemented within the display device of FIG. 1 supporting the enhanced demo mode.

FIG. 3A is an illustrative embodiment of a screen display generated by a display device of FIG. 2A for placing the display device into a Retail operating mode.

FIG. 3B is an illustrative embodiment of a screen display generated by a display device of FIG. 2A for placing the display device into an operating mode that supports demos.

FIG. 3C is an illustrative embodiment of a screen display generated by a display device of FIG. 2A for selecting a particular demo supported by the display device.

FIG. 4 is a first exemplary embodiment of the operations conducted by the display device of FIG. 2A operating in the Enhanced Demo mode.

FIG. 5 is a second exemplary embodiment of the operations conducted by the display device of FIG. 2A operating in the Enhanced Demo mode.

### DETAILED DESCRIPTION

Herein, for the purposes of explanation, numerous specific details are set forth in order to provide a thorough understanding of the invention. It will be apparent; however, to one skilled in the art that the invention may be practiced without some of these specific details. In addition, the following description provides examples, and the accompanying drawings show various examples for the purposes of illustration. However, these examples should not be construed in a limiting sense as they are merely intended to provide examples of embodiments of the invention rather than to provide an exhaustive list of all possible implementations. Also, in some instances, well-known structures and devices are not shown in block diagram form in order to avoid obscuring the details of the disclosed features of various described embodiments.

In the following description, certain terminology is used to describe certain features of the invention. For instance, the term “communication link” is generally defined as an information-carrying medium that establishes a communication pathway. Examples of the medium include a physical medium (e.g., electrical wire, optical fiber, cable, bus traces, etc.) or a wireless medium (e.g., air in combination with wireless signaling technology).

The term “demo content” is displayable and/or auditory information that is intended for play back on a device (e.g., display device) in order to highlight the features of that device. In contrast, “advertising content” is displayable and/or auditory information for play back on a device, where the information is intended to advertise particular goods and/or services and does not pertain to the device itself.

Also, the term “display device” is generally defined as an electronic device with display capabilities and a presence sensor. Such display capabilities may range from an electronic device having an integrated display to an electronic device having no integrated display screen, but featuring one or more connectors that can be connected to route displayable content to an external display screen. Examples of a display device include, but are not limited or restricted to a flat panel television (e.g., cathode ray tube “CRT”, liquid crystal display “LCD”, plasma, organic light-emitting diode “OLED”, or any television with another type of display technology), a computer, a video game console, a portable digital versatile disc (DVD) player, a handheld device (e.g., netbook, cellular phone, personal digital assistant “PDA,” etc.), or the like.

According to one embodiment of the invention, the “presence sensor” is an infrared sensor that scans for moving objects in horizontal and/or vertical directions. In normal operation, the presence sensor communicates with logic within the display device in order to alter luminance of the display screen, where if no movement is detected for a selected scan interval (e.g., from seconds to over one hour), the display screen is turned off. However, the presence sensor may be configured to operate in a different manner when the display device is placed into a particular operating mode (Enhanced Demo mode). For instance, the presence sensor may be configured to detect a non-moving or slow-moving object (e.g., a customer) in front of the display device for a predetermined period of time (e.g., 15 seconds, 30 seconds, one minute, etc.) and to signal processing logic to interrupt play back of streaming advertising content for stored demo content if such play back is permitted (since there may be periods of time when play back is not permitted to avoid repetitive play back of the demo content without sufficient play back of the advertising content). For instance, where the display device is a SONY® BRAVIA® ECO™ television, the presence sensor is normally design to achieve luminance reduction, such as signaling power reduction of the backlight. However, when the television is placed into Enhanced Demo mode in a Retail operational mode, the presence sensor is re-configured to now detect the presence of customers in front of the television and to signal processing logic to play back the demo content if permitted at that time.

The terms “logic” is generally defined as hardware and/or software configured to perform one or more functions. One example of a certain type of logic is a processor being one or more integrated circuits that process signals for rendering content for display. The content may include graphics, images, images or video with or without audio. Another example of a certain type of logic is software, which is generally describes as a series of executable instructions in the form of an application, an applet, or even a routine. The software may be stored in any type of machine readable medium such as a programmable electronic circuit, a semiconductor memory device such as volatile memory (e.g., random access memory, etc.) and/or non-volatile memory such as any type of read-only memory (ROM) or flash memory, a portable storage medium (e.g., Universal Serial Bus “USB” drive, optical disc, digital tape), or the like.

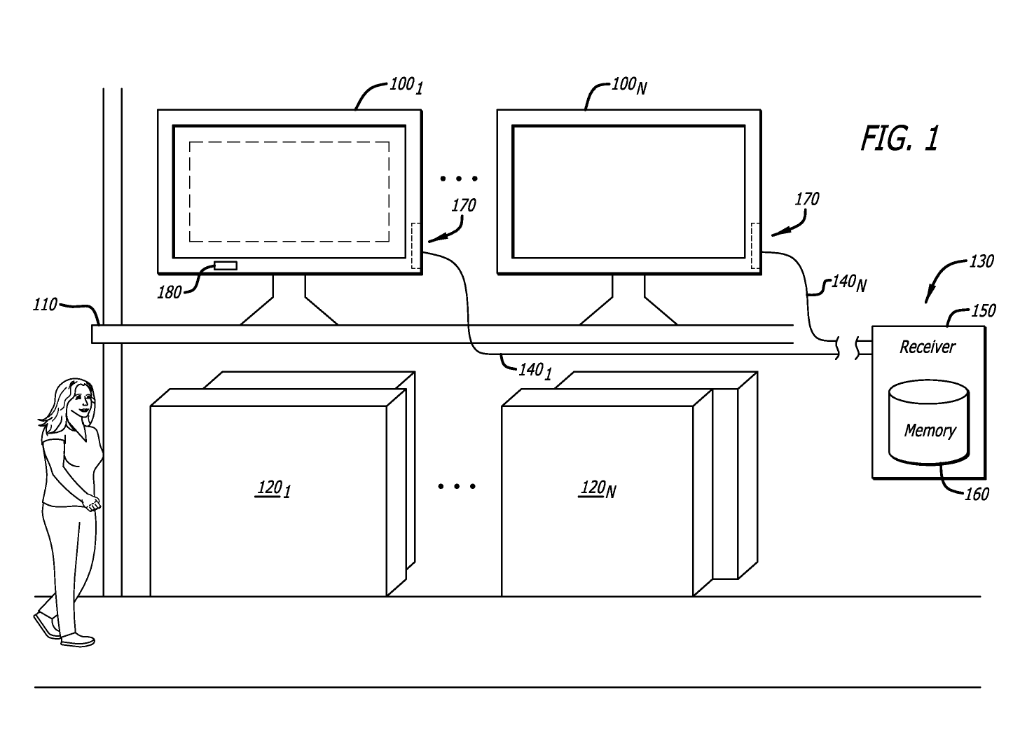

Referring to FIG. 1, an exemplary embodiment of multiple display devices residing in a non-assisted commercial environment is shown. According to this embodiment of the invention, display devices 100₁-100_{N} (N≧2) are placed on a storage rack 110 in order to elevate these devices above an aisle walkway, and in some situations, are placed behind boxed versions 120₁-120_{N} of these display devices bordering the walkway. This environment, which promotes the separation of display devices 100₁-100_{N} from a customer and prevents the customer from altering the operating states of display devices 100₁-100_{N}, is referred to as a “non-assisted commercial environment,” namely a retail environment that does not encourage physical interaction with or testing of the display device by the customer before purchase.

Herein, all of display devices 100₁-100_{N} are in communication with a content forwarding system 130 via communication links 140₁-140_{N} and are tuned to receive the same in-store channel for play back on its display screen. According to one embodiment of the invention, content forwarding system 130 includes a receiver 150 that receives displayable content, such as advertising content, from a remote source (not shown). Receiver 150 may be configured to receive advertising content that is transmitted via satellite, optical or wired lines, wireless or the like. The advertising content is stored in memory 160 of receiver 150. The stored advertising content is subsequently streamed to each display device 100₁-100_{N}. The advertising content may be routed as YPbPr and baseband audio, although other analog or digital transmission schemes may be used. Of course, the advertising content may be transmitted via an HDMI port upon receipt and without prolonged or any storage within memory 160.

Besides receiving advertising content via a remote source, one or more display devices (e.g., at least display device 100₁) may be adapted to receive uploaded information, such as software, a demo configuration file or demo content, via a secondary communication port. For instance, display device 100₁ may include one or more connectors 170, being any type of input/output (I/O) connectors such as a USB connector onto which a USB drive may be coupled, in order to upload the demo content and a demo configuration file that lists the particular portions forming the demo content. The demo content may be displayed by display device 100₁ when it is operating in an Enhanced Demo mode and detects prolonged presence of one or more customers in front of display device 100₁ (hereinafter referred to as a “presence triggering event”) as described below.

More specifically, display device 100₁ may be configured to operate in one of two operational states: Home and Retail. For instance, when operating in the “Home” operational state, display device 100₁ may be configured to take greater advantage of power saving features, such as activating a presence sensor 180 that is adapted to power-down display device 100₁ if no movable objects are sensed in front of display device 100₁ for a prescribed period of time. According to one embodiment, presence sensor 180 is an infrared sensor placed in the lower center part of a front face of display device 100₁ to scan for moving objects in a range of 30° to 80° in both horizontal and vertical directions. This sensor 180 is in communication with logic within display device 100₁ to alter the luminance of the backlight associated with display device 100₁. If no movement is detected for a selected scan interval (e.g., from seconds to over one hour), the logic will cause display device 100₁ to turn off (or power down) its screen.

More pertinent to the invention, however, display device 100₁ may be placed in the “Retail” operational state, which features two selectable modes; namely, Normal mode or Enhanced Demo mode. In Normal mode, display device 100₁ receives content from content forwarding system 130 and simply displays such content. However, when display device 100₁ is placed in Enhanced Demo mode, presence sensor 180 is re-configured so that display device 100₁ continues to display the streaming advertising content without interruption, but in response to detecting the presence of customers in front of display device 100₁ for a prolonged period of time e.g., greater than 15 seconds), display device 100₁ now starts to display the demo content. Such presence may be detected through sensed movement, vibration or the like.

Herein, in response to detecting customer presence, display device 100₁ executes software, retrieved from internal memory or from a portable storage medium coupled to USB connector 170, which causes display device 100₁ to activate presence sensor 180 and re-configure this sensor to operate in a different manner. Namely, sensor 180 monitors for prolonged movement in front of display device 100₁ in lieu of its normal operation of monitoring for the absence of movement. Upon detecting such movement, display device 100₁ temporarily interrupts the display of the advertising content received by its HDMI or other communication port via communication link 140₁. During this interruption, the demo content has been either previously uploaded into internal memory at manufacture or during initialization or is currently stored in portable storage medium coupled to connector 170. This allows for the demo content to be dynamically changeable. This demo content is played back for display in order to highlight certain features of display device 100₁.

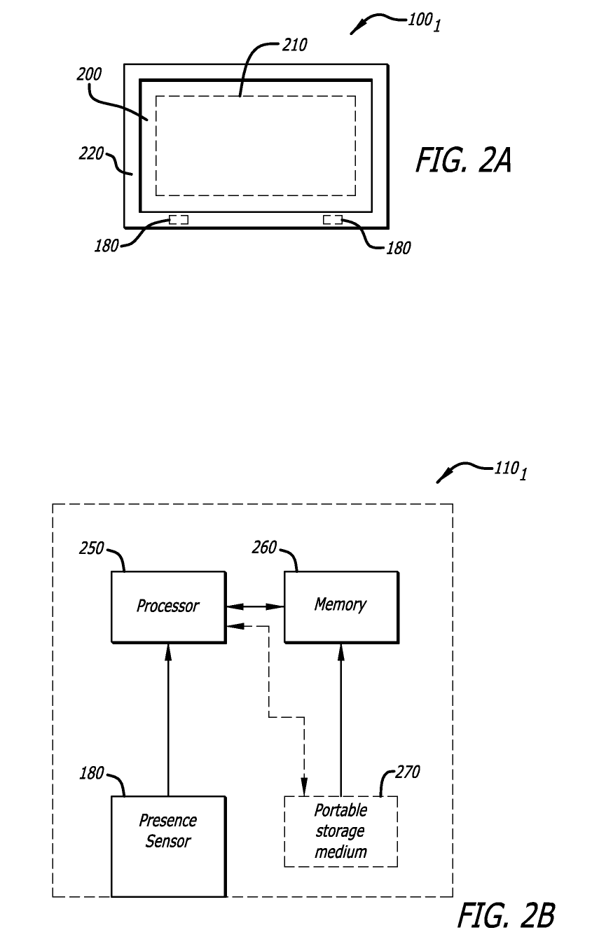

Referring to FIG. 2A, a first exemplary embodiment of a display device 100₁ that supports an Enhanced Demo mode is shown. According to this embodiment of the invention, display device 100₁ is a flat panel television that features a screen 200, a rear casing 210 and a bezel 220. Rear casing 210 houses the backlight, processing circuitry and other logic that controls the operation of display device 100₁. Bezel 220 is situated to surround and partially overlay the perimeter of screen 200. According to one embodiment of the invention, presence sensor 180 is sized to protrude from bezel 220 and is not obscured by bezel 220. Of course, in lieu of a single presence sensor, multiple presence sensors may be used to monitor for movement at different areas in front of display device 100₁. Also, these sensor(s) 180 may be coupled to an outer surface of bezel 220 in lieu of being substantially contained within bezel 220.

Referring now to FIG. 2B, an exemplary embodiment of components implemented within display device 100₁ of FIG. 2A and utilized when display device 100₁ is placed in Enhanced Demo mode is shown. Herein, display device 100₁ comprises presence sensor 180, a processor 250 and internal memory 260. More specifically, when display device 100₁ is placed in Enhanced Demo mode, presence sensor 180 detects a continuous interruption of light photons in front of display device 100₁ for a prolonged period of time (e.g., 15 seconds or longer) and transmits a presence signal to processor 250.

Upon detecting the presence signal, processor 250 executes logic to play back the demo content that is stored in internal memory 260. Alternatively, as represented by dashed lines, the executed logic may be stored within a portable storage medium 270 (e.g., USB drive) or processor 250 may fetch the demo content, such as one or more pre-stored video clips, from portable storage medium 270.

As an illustrative example, when placed in Enhanced Demo mode, display device 100₁ activates presence sensor 180 that scans an environment in front of display device 100₁ to determine movement within the scanned area. Concurrently, a text message may be generated to overlay the streaming advertising content that invites a customer to wait in front of display device 100₁ to see the demo content. Upon determining that the consumer is in front of display device 100₁, presence sensor 180 signals processor 250 within display device 100₁ to immediately play back the demo content. Alternatively, processor 250 may cause another text message to be generated to overlay the streaming advertising content, where the second text message requests the customer to remain in front of display device 100₁ for a few more seconds. The second text message is to ensure that a customer wants display device 100₁ to display the demo content, and the pausing by the customer in front of display device 100₁ was not coincidental to the display of the first text message.

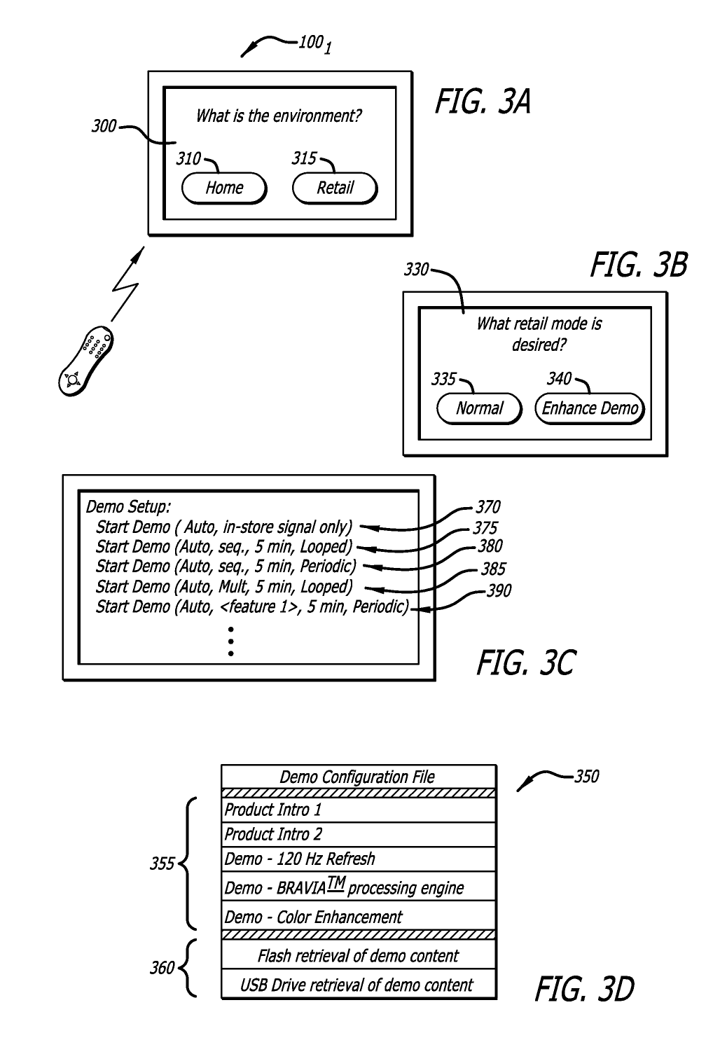

Referring to FIG. 3A, an illustrative embodiment of a screen display generated by display device 100₁ of FIG. 2A for placing display device 100₁ into the Retail operational state is shown. Herein, according to one embodiment of the invention, upon initial power-up, display device 100₁ displays an initialization screen display 300. Initialization screen display 300 allows the user to select a current operating state for display device 100₁ by selecting one of a plurality of option buttons 310 and 315. A first option button 310, if selected, places display device 100₁ into the Home operational state. A second option button 315, if selected, places display device 100₁ into the Retail operational state.

After selecting second option button 315 and placing display device 100₁ into the Retail operational state, a secondary screen display 330 is rendered as shown in FIG. 3B. Secondary screen display 330 illustrates what types of Retail operating modes are available and allows the user to select one of a plurality of option buttons 335 and 340 rendered on a screen of display device 100₁. A first option button 335 represents a Normal mode in which display device 100₁ operates to merely play back or display the advertising content received over one of its communication ports such as HDMI port, a YPbPr port and the like. A second option button 340 represents an Enhanced Demo mode, which causes execution of logic dedicated in supporting demo operations of display device 100₁ in Enhanced Demo mode.

More specifically, according to one embodiment of the invention, logic for supporting demo operations (hereinafter referred to as “demo-control logic”) is uploaded into internal memory (e.g., non-volatile memory such as flash or battery backed-up random access memory) within display device 100₁ during manufacture. In response to selecting second option button 340, the demo-control logic is retrieved and executed by the processor. Execution of the demo-control logic causes activation of the presence sensor to capture changes in the amount of ambient light detected or vibration caused by movement in front of the display device and to capture such measurements with pre-stored levels for use in detecting prolonged movement in front of the display device.

Upon detection, display device 100₁ fetches the demo configuration file and the demo content from internal memory. Herein, the demo content is stored with corresponding control information that identifies the type of demo content uploaded. For instance, the control information may identify the demo content to be one of a number of content types, such as graphics (text), graphics (text) with audio, images, images and audio, or video for example. The control information is fetched along with the demo content and may be used by display device 100₁ to determine behavioral characteristics of display device 100₁.

Alternatively, the control information may be stored as part of the demo content. For instance, the demo content may be separated into definable segments (e.g., frames, cells, etc.) with each segment featuring a header portion that includes content type. The content type information is used by display device 100₁ to determine behavioral characteristics of display device 100₁.

FIG. 3C is an illustrative embodiment of a screen display generated by a display device of FIG. 2A for placing display device 100₁ into one of a plurality of Enhanced Demo modes is shown. Herein, display device 100₁ is placed in the Enhanced Demo mode and, upon placement of this mode, display device 100₁ accesses the demo configuration file to identify and subsequently display the number of demo options available to the retailer as provided by the demo configuration file. For instance, as shown in FIG. 3D, demo configuration file 350 may feature demo video clips 355 that are directed to explanation of display device 100₁ as a whole (Product Intro) or particular features of display device 100₁. Also, demo configuration file 350 may include fields 360 to direct display device 100₁ to fetch and display other demo content from internal memory therein or from the portable storage medium.

Referring back to FIG. 3C, upon accessing the demo configuration file, display device 100₁ displays a plurality of demo options available to the retailer. The retailer is able to select one or more of these demo options, and based on the selection, play back these demo video clip(s) in response to detection of a presence triggering event. The manner of such play back may be “periodic” or “looped”. Periodic play back means that a series of demo video clips (e.g., one or more demo video clips) are played back and followed by at least a predetermined amount of time for play back of the streaming advertising content. According to one embodiment, the amount of time for playback of the streaming advertising content may be static or adjusted by the retailer, normally from zero minutes (immediate looped playback) and multiple minutes. The play back duration of the demo video clips does not to exceed two minutes for each detected presence triggering event. Looped play back means that, in response to detecting a presence triggering event, one or more demo video clips may be displayed successively with play back of streaming advertising interspersed between the demo video clips.

For instance, upon selection of a first demo option 370, only the in-store advertising content is used by display device 100₁ for demo purposes. However, upon selection of a second demo option 375, the display device automatically plays back one or more demo video clips in a looped play back manner, namely each demo video clip is directed to a different feature and a predetermined interval (e.g., five minutes) is required between the display of each demo video clip. The “predetermined interval” is a mandatory time period in which demo content is precluded from being displayed and only in-store advertising content is allowed to be displayed even if presence triggering events are detected.

Third demo option 380 involves the display device automatically playing back a video clip in a periodic play back fashion, where a demo video clip is played back followed by a predetermined interval (e.g., five minutes) for display of the streaming advertising content. After the predetermined interval, if another presence triggering event is detected, display device 100₁ is permitted to play back the demo content which may involve the same or different demo video clips.

If selected, a fourth demo option 385 involves the display of multiple demo video clips forming the demo content in a looped play back fashion with a predetermined interval interposed between the multiple demo video clips. Each demo video clip being directed to a different feature for display device 100₁. In contrast with second demo option 380 that involves a serial display of demo video clips, it is noted that multiple demo video clips are shown in between each predetermined interval.

A fifth demo option 390 involves the display in a periodic play back fashion of a demo video clip that is directed to a single feature of display device 100₁ and at least the predetermined interval is required after each display of the demo video clip. For instance, the demo video clip may be directed to a particular feature such as the processing engine used by display device 100₁. Herein, upon detection of a presence triggering event, the demo video clip directed to the processing engine is played back, and thereafter, the predetermined interval is required. Thereafter, if another presence triggering event is detected, the demo video clip directed to the processing engine is played back again. During the predetermined interval, according to one embodiment of the invention, no graphics or audio advising viewers as how to activate play back of the demo content is provided.

It is contemplated that, where the demo content is stored in flash memory, repeated accesses to flash memory may cause the lifetime of the flash to be reduced, and hence, the lifetime of the television may be reduced as well. One possibility to mitigate this issue is to copy the demo content into random access memory (RAM) and to read the demo content from RAM instead of flash memory. On boot, where the display device is a television, it already copies television software from flash memory to RAM. The television would need to do this for the demo content as well.

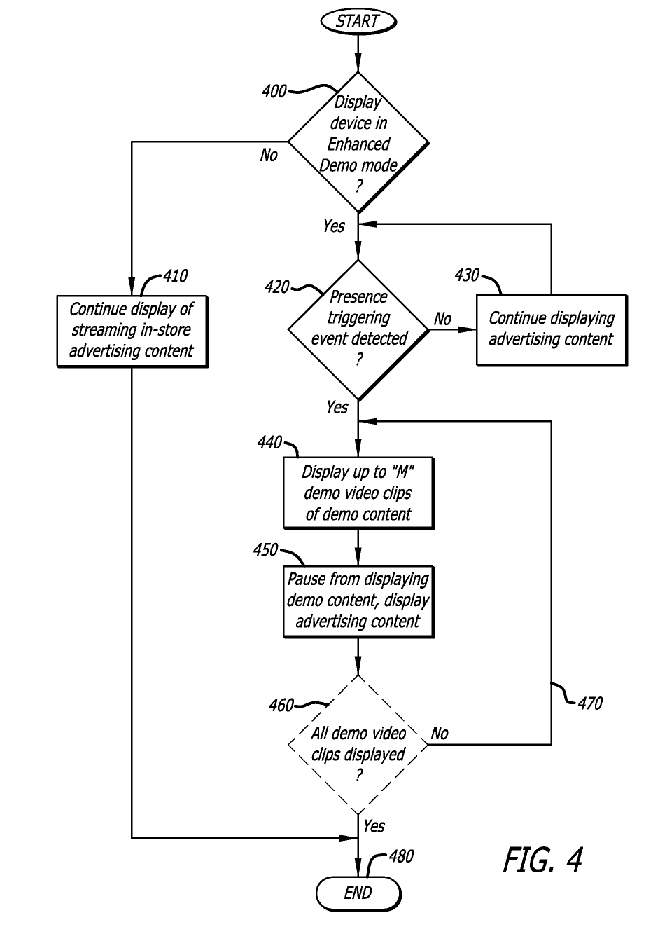

FIG. 4 is a first exemplary embodiment of the operations conducted by the display device of FIG. 2A operating in the Enhanced Demo mode. Initially, a determination is made whether the display device has been placed into Enhanced Demo mode (item 400). If not, the in-store advertising content is merely shown by the display device (item 410). However, if the display device has been placed into Enhanced Demo mode, a determination is made whether a presence triggering event has been detected (item 420).

If a presence triggering event is not detected, the display device simply continues to monitor for a presence triggering event (item 430). The streaming advertising content continues to be displayed at this time. However, if a presence triggering event is detected, the display device executes logic that causes demo content to be displayed in order to showcase attributes for the display device (item 440). The demo content may be “M” demo video clips (M≧1), each corresponding to an attribute to be displayed before discontinuing the display of demo content and requiring in-store advertising content to be displayed for a predetermined interval. In other words, after displaying “M” demo video clip(s), a mandatory pause for the predetermined duration is conducted by the display device in order to ensure that the demo content is interspersed with the advertising content streamed into the display device (item 450). Thereafter, as an optional feature, a determination may be made as to whether demo video clips for all of the attributes associated with the selected demo content have been shown (item 460). If not, the display device continues to cycle through the remaining demo video clips forming the demo content (item 470). Otherwise, the operations conducted by the display device in response to a presence triggering event cease (item 480).

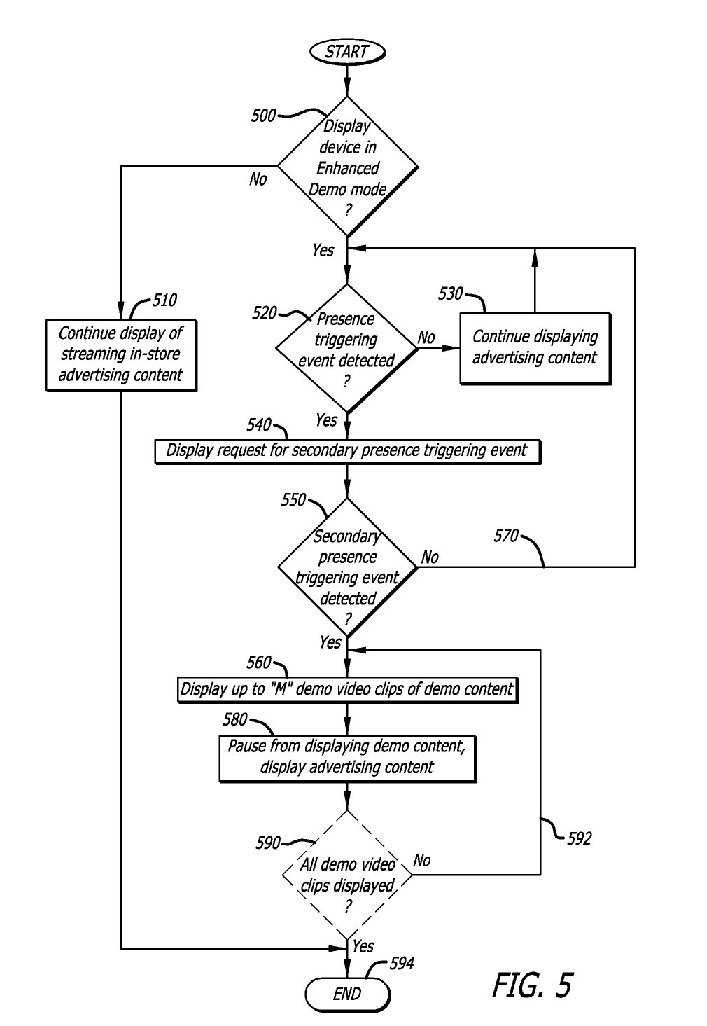

FIG. 5 is a second exemplary embodiment of the operations conducted by the display device of FIG. 2A operating in the Enhanced Demo mode. Initially, a determination is made whether the display device has been placed into Enhanced Demo mode (item 500). If not, the in-store advertising content is merely shown by the display device (item 510). However, if the display device has been placed into Enhanced Demo mode, a determination is made whether a presence triggering event has been detected (item 520).

If a presence triggering event is not detected, the display device simply continues to monitor for a presence triggering event and the streaming advertising content continues to be displayed (item 530). However, if a presence triggering event is detected, the display device executes logic that causes displayable information (e.g., a text message, an image, etc.) to be displayed to request the customer to perform a secondary presence triggering event in order to confirm that the customer requests a demo (item 540). The secondary presence triggering event may be the same or different from the initial presence triggering event.

If the presence triggering event is detected prior to time-out, namely a time interval during which the display device monitors for the secondary presence triggering event, the demo content is displayed in order to showcase attributes for the display device (items 550 and 560). The demo content may be “M” demo video clips, which correspond to the number “M” of attributes to be displayed before requiring a predetermined interval for display of in-store advertising content. Otherwise, the display device returns to monitor for an initial presence triggering event (item 570).

After displaying these demo attributes, a mandatory pause for the predetermined invention is conducted by the display device in order to prevent cycling of the demo content and to ensure that the demo content is interspersed with the advertising content provided streamed into communication ports of the display device (item 580). Thereafter, as an optional feature, a determination may be made as to whether demo video clips for all of the attributes associated with the selected demo content have been shown (item 590). If not, the display device continues to cycle through the remaining demo video clips (item 592). Otherwise, the operations conducted by the display device in response to a presence triggering event cease (item 594).

Having disclosed exemplary embodiments and the best mode, modifications and variations may be made to the disclosed embodiments while remaining within the scope of the embodiments of the invention as defined by the following claims.

What is claimed is:

1. A method for controlling periodically play back of demo content by a display device, the method comprising:
monitoring for a triggering event by a presence sensor within the display device, the triggering event being a detection of a non-moving or slow-moving object remaining in front of the display device for a predetermined period of time;
automatically playing back the demo content for a period of time in response to detecting the triggering event;
halting play back of the demo content after the period of time has elapsed; and
continuing to play back the streaming advertising content by the display device.

2. The method of claim 1, wherein play back of the streaming advertising content by the display device is conducted for a second period of time even if another triggering event is detected during the second period of time.

3. The method of claim 1, wherein the monitoring of the triggering event includes scanning for objects in front of the display device.

4. The method of claim 3, wherein the scanning for objects includes scans for the non-moving or slow-moving object remaining in front of the display device for over thirty seconds.

5. The method of claim 3, wherein the scanning is an infrared scan such that slow-movement is detected through comparison of results from multiple successive scans.

6. The method of claim 1, wherein the automatic playing back of the demo content for the first period of time includes displaying one or more video clips directed to features of the display device.

7. The method of claim 1, wherein prior to automatically playing back the demo content for the first period of time, the method further comprises:
repeating to monitor for a second triggering event, and upon detecting of the second triggering event, the demo content is automatically played back.

8. An apparatus comprising:
a memory;
a presence sensor to detect presence of a customer in front of the apparatus for a prolonged period of time and to generate a control signal in response to detection of an object being in front of the apparatus for the prolonged period of time; and
a processor coupled to the presence sensor, the processor to (i) permit play back of a first type of content for a first period of time upon receipt of the control signal where the first type of content is played back in lieu of playing back a second type of content that is normally processed for play back by the processor, (ii) permit play back of the second type of content for a second period of time after the first period of time has elapsed, and (iii) play back the first type of content after the second period of time has elapsed and the object is detected to remain present in front of the apparatus for the prolonged period of time.

9. The apparatus of claim 8, wherein the processor to permit play back of the second type of content for the second period of time after the first period of time has elapsed regardless whether another object remains present in front of the apparatus.

10. The apparatus of claim 8 further comprising a display screen.

11. The apparatus of claim 8, wherein the presence sensor is configured to detect vibrations on a floor in front of the display screen.

12. The apparatus of claim 8, wherein the presence sensor is configured to detect non-movement or slow-movement of the object in front of the display screen.

13. The apparatus of claim 12 further comprising:
a housing including a rear casing and a bezel, the rear casing containing the processor and memory and the bezel surrounding the display screen.

14. The apparatus of claim 12, wherein the presence sensor is integrated within the bezel so that a portion of the presence sensor is substantially flush with an outer surface of the bezel.

15. The apparatus of claim 9, wherein the processor to permit play back of the first type of content for the first period of time by automatically displaying one or more video clips being demo content in lieu of display of streaming advertising content being the second type of content.

16. A software stored within a memory and executed by a processor implemented within a display device being an electronic device with display capability, to perform the operations of:
monitoring for a triggering event during display of a streaming advertising content received from a remote source, the triggering event being detection of a non-moving or slow-moving object in front of the display device for a predetermined period of time;
automatically displaying a demo content uploaded into internal memory of the display device for a first period of time; and
continuing the display of the streaming advertising content by the display device after the first period of time has elapsed, the display of the streaming advertising content being for a second period of time being at least equal in duration to the first predetermined period of time during which the demo content cannot be displayed.

17. The software of claim 16, wherein the automatic displaying of the demo content for the first period of time includes displaying one or more video clips directed to features of the display device.
